(19) United States
(12) Patent Application Publication
(10) Pub. No.: US 2005/0052783 A1
(43) Pub. Date: Mar. 10, 2005

(54) Combined magnetic head and manufacturing method thereof

(75) Inventor: Takashi Suda, Kanagawa (JP)

Correspondence Address: SUGHRUE MION , PLLC, 2100 Pennsylvania Avenue, N.W., Washington, DC, 20037-3213, US

(73) Assignee: FUJI PHOTO FILM CO., LTD.

(21) Appl. No.: 10/829,178

(22) Filed: Apr. 22, 2004

(30) Foreign Application Priority Data
Sep. 9, 2003 (JP) 2003-317310

(51) Int. Cl. G11B 5/265

(52) U.S. Cl. 360/121

(57) ABSTRACT

A combined magnetic head comprises a DC erase head for magnetizing a servo band of a magnetic tape in one of longitudinal directions of the magnetic tape with contacting the magnetic tape that is running; and a servo write head for magnetizing a servo signal in a reverse direction for the one direction and writing the servo signal on the servo band, with contacting the magnetic tape, wherein the DC erase head and the servo write head are integrally configured through a non-magnetic body, and wherein a DC erase head gap of the DC erase head and a servo write head gap of the servo write head are aligned in the longitudinal direction, and are simultaneously formed with one mask by a photolithography method.

### BACKGROUND OF THE INVENTION

1. Field of the Invention

The present invention relates to a combined magnetic head that enables an SN (Signal/Noise) ratio of a read signal of a servo signal to be improved, and a manufacturing method thereof.

2. Description of the Related Art

These years, in a magnetic tape a high density recording has progressed and there are some tapes having a capacity of around 100 gigabytes for a backup of a computer. Therefore, in the magnetic tape several hundreds of data tracks are formed in lateral directions thereof. Accordingly, a width of the data tracks extremely becomes narrow, and also a distance between adjacent data tracks extremely becomes narrow. Therefore, in order to make a recording/reproducing element of a magnetic head trace the data tracks, a servo signal is written on the magnetic tape in advance, and while reading the servo signal with the magnetic head, a position of the magnetic head (position of the lateral directions of the magnetic tape) is servo-controlled (see paragraph 0021 and FIG. 3 in Japanese Paten Laid-Open Publication No. Hei 8-30942).

And the servo signal is recorded on a non magnetized magnetic tape so as to be magnetized in one direction by giving a recording current to a servo write head.

In other words, as shown in FIG. 5A, conventional servo signals SS″ are formed on non magnetized servo bands SB″ by flowing a recording current pulse PC″ (hereinafter referred to as the “current pulse” in abbreviation) consisting of a zero current and a plus pulse current in order to avoid a saturation phenomenon of a servo read element (MR (Magneto Resistive) element). If such the recording current pulse PC″ is used, as shown in FIG. 5B a magnetic tape MT″ is not magnetized in areas except for servo patterns SP″ when the recording current pulse PC″ is the zero current; and when the plus pulse current of the recording current pulse PC″ flows, the servo patterns SP″ are magnetized in one direction by a leak magnetic flux from servo gaps, thereby as a result the servo signals SS″ being written. On the other hand, in a magnetic tape recording/reproducing apparatus a change point of a magnetization in the servo signals SS″ is detected as a change of an electric resistance by the servo read element, and as a read signal thereof, the change point of the magnetization is output in a differential waveform (voltage value). Therefore, the larger the change of the electric resistance becomes, the higher a peak voltage value of the read signal of the servo signals SS″ becomes, thereby the SN ratio of the read signal being improved. Accordingly, when changes of the servo signals SS″ themselves are large and a read area is large due to a wide width of the servo read element, as shown in FIG. 5C a peak voltage value of a read signal RSL″ of the servo signals SS″ becomes high.

Whereas, hereafter the high density recording of the magnetic tape is foreseen to progress till around several tens of terabytes. Therefore, in a case of the magnetic tape a number of data tracks increases, the width of the data tracks and a distance between the adjacent data tracks become narrower, and the magnetic tape itself becomes a thin layer. Based upon this, a detectable magnetism amount in reading the servo signals SS″ decreases and a change of a magnetization amount of the servo signals SS″ detectable by the servo read element also becomes small. Accordingly, as shown in FIG. 5D a peak voltage value of a read signal RSS″ of the servo signals SS″ becomes small, thereby the SN ratio of the read signal RSS″ deteriorating. As a result, in the magnetic tape recording/reproducing apparatus the servo signals SS″ become not able to be accurately read, thereby highly accurate position control of the magnetic head being not able to be performed.

Consequently, in an undisclosed invention (Japanese Patent Application No. 2003-110396) which the inventors formerly filed, servo signals are written on servo bands in any one direction of longitudinal directions of a magnetic tape with being magnetized in a reverse direction for the any one direction, thereby a change rate and change amount of a magnetic field in reading the servo signals with a servo read element being made large. In addition, another undisclosed invention (Japanese Patent Application No. 2003-116667) which the inventors formerly filed is a combined magnetic head (servo head write assembly) where are integrally configured a DC erase head for magnetizing servo bands of a magnetic tape in any one of longitudinal directions and a servo write head for writing servo signals in a reverse direction for the any one direction.

However, also in the undisclosed inventions, as shown in FIG. 4A, if a combined magnetic head H′ is manufactured through a non-magnetic magnetic body 50′ by joining a DC magnetizing head 10′ having DC erase head gaps 10G′ (hereinafter referred to as the “servo head gaps” in abbreviation) and a servo write head 20′ (hereinafter referred to as the “servo head” in abbreviation) having servo write head gaps 20G′, each of the DC erase head gaps 10G′ and the servo write head gaps 20G′ could be displaced by ΔD in lateral directions of a magnetic tape MT1′ due to a manufacturing error.

And as shown in FIG. 4B, if servo signals SS′ are written on the magnetic tape MT1′ by such the combined magnetic head H1′, there is a problem that a band portion of direct current magnetization signals DS′ magnetized by direct current on the magnetic tape MT1′ through the DC erase head gaps 10G′ and another band portion of the servo signals SS′ written through the servo write head gaps 20G′ are displaced by the ΔD in the lateral directions.

In addition, in the magnetic tape MT1′ magnetized by the combined magnetic head H1′ since when reading the servo signals SS′ with the servo read element, there are no direct current magnetization signals DS′ in a portion (portion where the direct current magnetization signals DS′ are not written) that is the band portion, where the servo signals SS′ are written, and is not magnetized by direct current, a change rate and change amount of a magnetic field become small, thereby there existing a problem that a position of the magnetic head is difficult to be accurately controlled.

Furthermore, in the magnetic tape MT1′ magnetized by the combined magnetic head H1′, data signals result in being written on a portion, which is the band portion (portion where the direct current magnetization signals DS′ are written) magnetized by direct current and where the servo signals SS′ are not written, and the direct current magnetization signals DS′ partially overlap the data signals, thereby there existing another problem that a noise is given.

Consequently, a combined magnetic head that enables the SN ratio of a read signal of a servo signal to be improved, and a manufacturing method thereof are strongly requested.

### SUMMARY OF THE INVENTION

A first aspect of the present invention for solving the problems described above is a combined magnetic head where a DC erase head for magnetizing a servo band of a magnetic tape in one of longitudinal directions of the magnetic tape with contacting the magnetic tape that is running and a servo write head for magnetizing a servo signal in a reverse direction for the one direction and writing the servo signal on the servo band with contacting the magnetic tape are integrally configured through a non-magnetic body, wherein a DC erase head gap of the DC erase head and a servo write head gap of the servo write head are aligned in the longitudinal direction, and are simultaneously formed with one mask by a photolithography method.

In accordance with such the combined magnetic head, with making the DC erase head gap positioned at an upstream side and the servo write head at a downstream side and their contacting the magnetic tape, whose all surface is demagnetized and which is running, at predetermined positions in lateral directions of the magnetic tape (hereinafter referred to as the “lateral directions” in abbreviation), a servo pattern can be formed by magnetizing a portion corresponding to the servo band of the magnetic tape in one direction of the longitudinal directions of the magnetic tape, for example, a travel direction of the magnetic tape (this direction assumes to be a “forward direction”); and writing the servo signal in a reverse direction (reverse direction for the one direction) with the servo write head without being displaced for the servo band magnetized in the forward direction.

Accordingly, since when reading the servo signal, for example, with a servo read element for the magnetic tape magnetized by such the combined magnetic head, a change rate and change amount of a magnetic field become large at a portion magnetized in the forward direction and a portion of the servo pattern magnetized in the reverse direction, an output of the servo signal becomes large. In addition, since a band portion magnetized in the forward direction and another band portion where the servo signal of the reverse direction is written accord in the lateral directions, the output of the servo signal does not partially lower, too. That is, the SN ratio of a read signal of the servo signal can be improved. Accordingly, based on the read signal, a position of a recording magnetic head in the lateral directions can be suitably controlled, thereby a data signal can be written on a data band not magnetized in the forward direction.

A second aspect of the present invention is a manufacturing method of a combined magnetic head that magnetizes a servo band of a magnetic tape in one direction of longitudinal directions of the magnetic tape with contacting it, magnetizes a servo signal in a reverse direction for the one direction, and writes the servo signal on the servo band, and which method comprises a first process where a DC erase head core main body and a servo write head core main body are integrally configured through a non-magnetic body, and a second process for simultaneously forming a DC erase head gap film formed at the DC erase head core main body and a servo write head gap film formed at the servo write head core main body at an arrangement aligned in the longitudinal directions by a photolithography method of using one mask.

In accordance with such the combined magnetic head, the head having the DC erase head gap and the servo write head gap aligned in the longitudinal directions of the magnetic tape can be manufactured as follows: after integrally configuring the DC erase head core main body and the servo write head core main body through the non-magnetic body (the first process), simultaneously form the DC erase head gap film formed at the DC erase head core main body and the servo write head gap film formed at the servo write head core main body at the arrangement aligned in the longitudinal directions by the photolithography method of using one mask (the second process), then form a surface magnetic film so as to coat the films by a sputtering method and the like, and perform polishing as needed.

### BRIEF DESCRIPTION OF THE DRAWINGS

FIG. 1 is an overall perspective view of a combined magnetic head related to an embodiment of the present invention.

FIGS. 2A to 2F are drawings showing a manufacturing method of the combined magnetic head related to the embodiment.

In FIGS. 3A and 3B, FIG. 3A is a plan view of the combined magnetic head related to the embodiment; and FIG. 3B is a drawing showing a magnetization state of a magnetic tape by the combined magnetic head.

In FIGS. 4A and 4B, FIG. 4A is a plan view of a conventional combined magnetic head; and FIG. 4B is a drawing showing a state where servo signals are written by the combined magnetic head.

FIGS. 5A to 5D are drawings illustrating a magnetic tape where conventional servo signals are written: FIG. 5A is a drawing showing a recording current pulse; FIG. 5B is a plan view of the magnetic tape; FIG. 5C is a drawing showing a read signal of a servo signal when a width of a read element is wide; and FIG. 5D is a drawing showing a read signal of the servo signal when a width of a read element is narrow.

### DESCRIPTION OF THE PREFERRED EMBODIMENTS

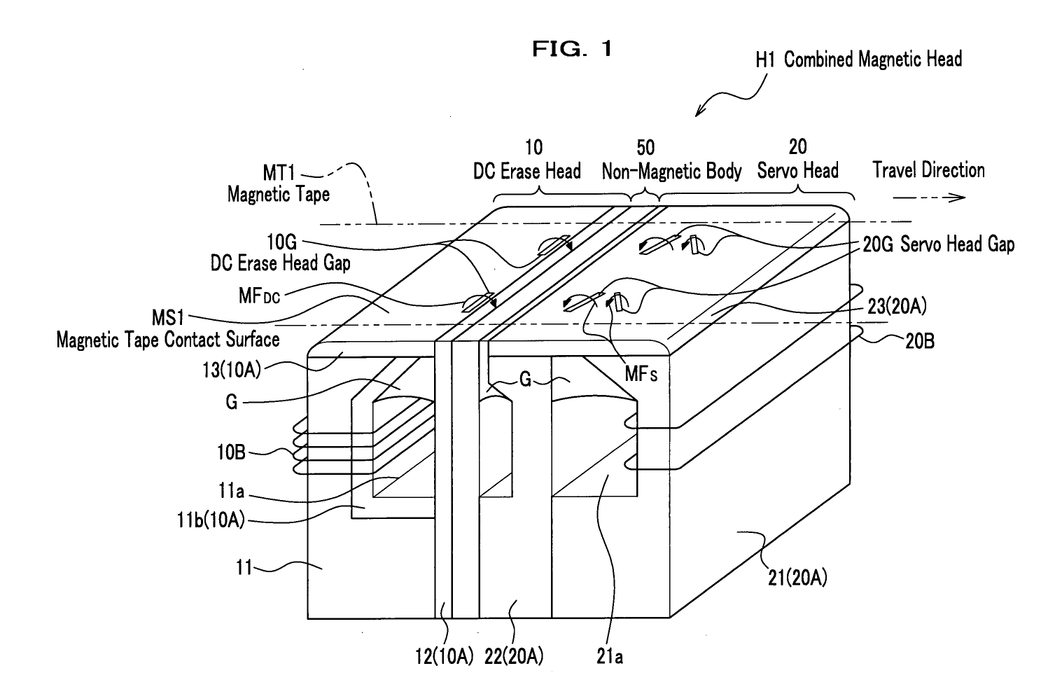

Hereinafter, one of embodiments of the present invention will be described, referring to FIGS. 1 to 3 as needed.

Meanwhile, a combined magnetic head H1 related to the embodiment is, for example, a head that magnetizes servo bands SB of a magnetic tape MT1 (see FIG. 3B), whose all surface is demagnetized by an alternating current demagnetization, in one direction of longitudinal directions of the magnetic tape MT1, magnetizes servo signals SS in a reverse direction for the one direction, and writes them.

[Configuration of Combined Magnetic Head]

As shown in FIG. 1, in the combined magnetic head H1 through a non-magnetic body 50 are integrally configured a DC (Direct Current) delete head 10 for magnetizing servo bands SB (see FIG. 3B) of the magnetic tape MT1 in a travel direction thereof with contacting the magnetic tape MT1 that is running, and a servo write head 20 (hereinafter referred to as the “servo head”) that magnetizes the servo signals SS (see FIG. 3B) in a reverse direction for the forward direction and writes them on the servo bands SB. And the combined magnetic head H1 has a magnetic tape contact surface MS1 across the DC erase head 10, the non-magnetic body 50, and the servo head 20.

Such the combined magnetic head H1 configures a servo writer (not shown) for writing the servo signals SS on the servo bands SB of the magnetic tape MT1 together with a tape running system (not shown) such as a supply reel, a winder, and a guide roller; a current generation circuit (not shown) for giving a direct current and the current pulse to the combined magnetic head H1; a current generation controller for controlling a current generation; and the like.

a) DC Erase Head

The DC erase head 10 is a head for magnetizing a portion corresponding to the servo bands SB of the magnetic tape MT1 in the forward direction by direct current, and is configured of a first base member 11 showing an approximately C-shape in a section view of a lateral direction thereof, a magnetic film 12 at a side of the non-magnetic body 50, a surface magnetic layer 13, and a coil 10B for generating a magnetic flux by direct current given by a current generation unit (not shown). In addition, the DC erase head 10 has DC erase head gaps 10G at a side of the magnetic tape contact surface MS1.

The first base member 11 has a coil groove 11a where the coil 10B is wound, and on an inner face thereof is formed a magnetic layer 11b by a sputtering method, a plating method, and the like. And a DC erase head core 10A is configured of the magnetic layer 11b, the magnetic film 12, and the surface magnetic layer 13; and a magnetic flux flow, which is generated in a direct current being given to the coil 10B, is designed to be able to transmit inside the DC erase head core 10A.

The magnetic layer 11b, the magnetic film 12, and the surface magnetic layer 13 are formed of magnetic materials having magnetism. Although kinds of the magnetic materials are not specifically limited in the present invention, they can be formed by being selected as needed, for example, from metal alloy magnetic materials such as an Fe—Ni alloy of soft magnetism called Permalloy, Sendust, Alperm, and an amorphous alloy.

On the other hand, the first base member 11 itself is formed of non-magnetic materials having non-magnetism, and as such the non-magnetic materials, are cited, for example, alumina titan carbide (Al₂O₃.TiC), non-magnetic ferrites, titan oxide calcium (CaO.nTiO₂), and the like.

The DC erase head gaps 10G are formed of non-magnetic materials such as silica (SiO₂). And the DC erase head gaps 10G are provided at the surface magnetic layer 13 so as to expose their surfaces at positions corresponding to a portion of the servo bands SB (see FIG. 3B) of the magnetic tape MT1. Here, for an easy description of the embodiment, it is assumed that the magnetic tape MT1 has two pieces of the servo bands SB (see FIG. 3B). Accordingly, when a direct current is given to the coil 10B as described later, leak magnetic fluxes MF_{DC} (Magnetic Flux) are generated, thereby the servo bands SB being able to be magnetized in the forward direction by direct current.

b) Servo Head

The servo head 20 is a head for writing the servo signals SS (see FIG. 3B) of the reverse direction on the portion corresponding to the servo bands SB of the magnetic tape MT1, is configured of a servo write head core 20A and a coil 20B for generating a magnetic flux with the current pulse given by the current generation unit (not shown), and has servo write head gaps 20G (hereinafter referred to as the “servo head gap”) at the side of the magnetic tape contact surface MS1.

The servo write head core 20A has a coil groove 21a, and is configured of a second base member 21 showing an approximately C-shape in a section view of a lateral direction thereof, a third base member 22 showing an approximately I-shape also in a section view of a lateral direction thereof, a surface magnetic layer 23. The second base member 21, the third base member 22, and the surface magnetic layer 23 are formed of magnetic materials having magnetism.

The servo head gaps 20G are formed of non-magnetic materials such as silica (SiO₂). And the servo head gaps 20G are, same as the DC erase head gaps 10G described before, provided at the surface magnetic layer 23 so as to expose their surfaces (see FIG. 3B) at positions corresponding to the portion of the servo bands SB of the magnetic tape MT1. Accordingly, when the current pulse is given to the coil 20B by the servo head gaps 20G as described later, leak magnetic fluxes MF_{S} are generated, thereby the servo signals SS being able to be written.

Furthermore, the servo head gaps 20G show an approximately “bottom-open-reverse-V letter” in a plan view, and respectively form bursts Ba (see FIG. 3B), which are magnetization portions for making a positive slanted angle for a travel direction of the magnetic tape MT1, and bursts Bb, which are magnetization portions for making a negative slanted angle for the travel direction of the magnetic tape MT1, with the servo signals SS written by the leak magnetic fluxes MFₛ, thereby servo patterns SP consisting of the bursts Ba and the bursts Bb being able to be written.

Accordingly, the DC erase head gaps 10G and the servo head gaps 20G corresponding to same servo bands SB are parallely provided in the longitudinal directions of the magnetic tape MT1.

[Non-Magnetic Body]

The non-magnetic body 50 is configured of non-magnetic materials having non-magnetism, and plays a role of magnetically insulating the DC erase head 10 and the servo head 20. Although as kinds of the non-magnetic materials forming the non-magnetic body 50, there is specifically no limitation in the present invention, for example, are cited a ceramic called AlTiC consisting of aluminum (Al), titan (Ti), and carbon (C), titan oxide calcium (CaO.nTiO₂), non-magnetic ferrites, and the like.

[Manufacturing Method of Combined Magnetic Head]

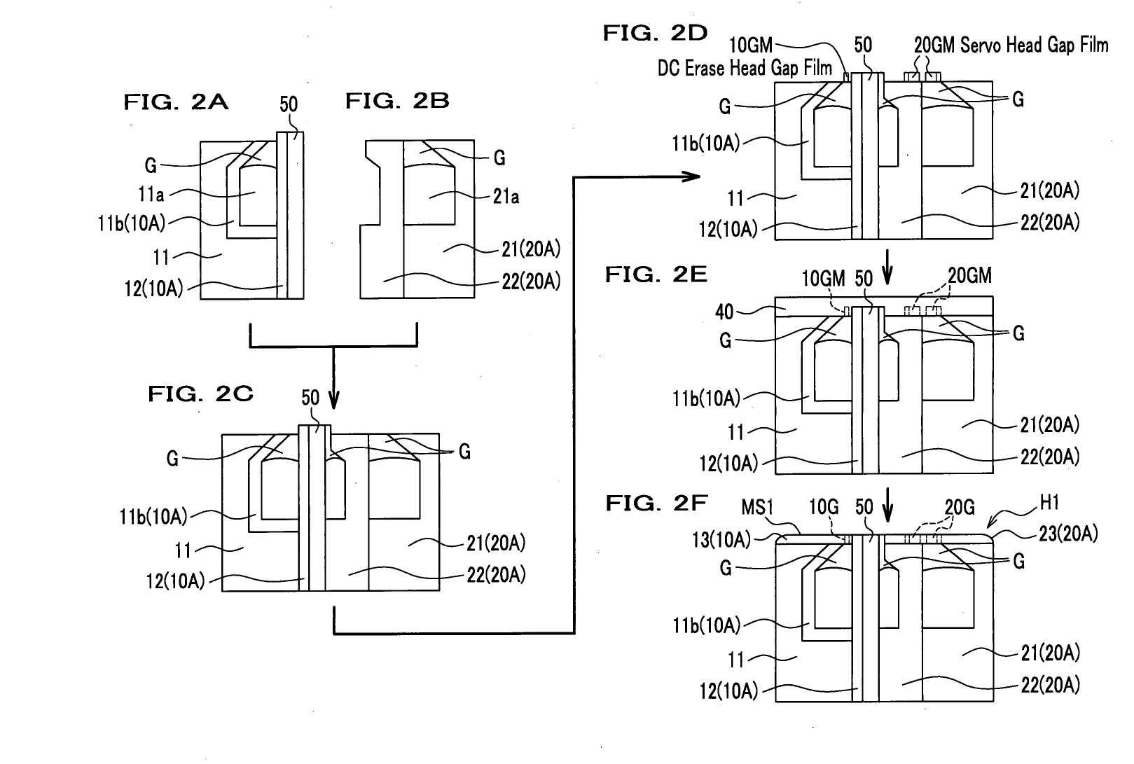

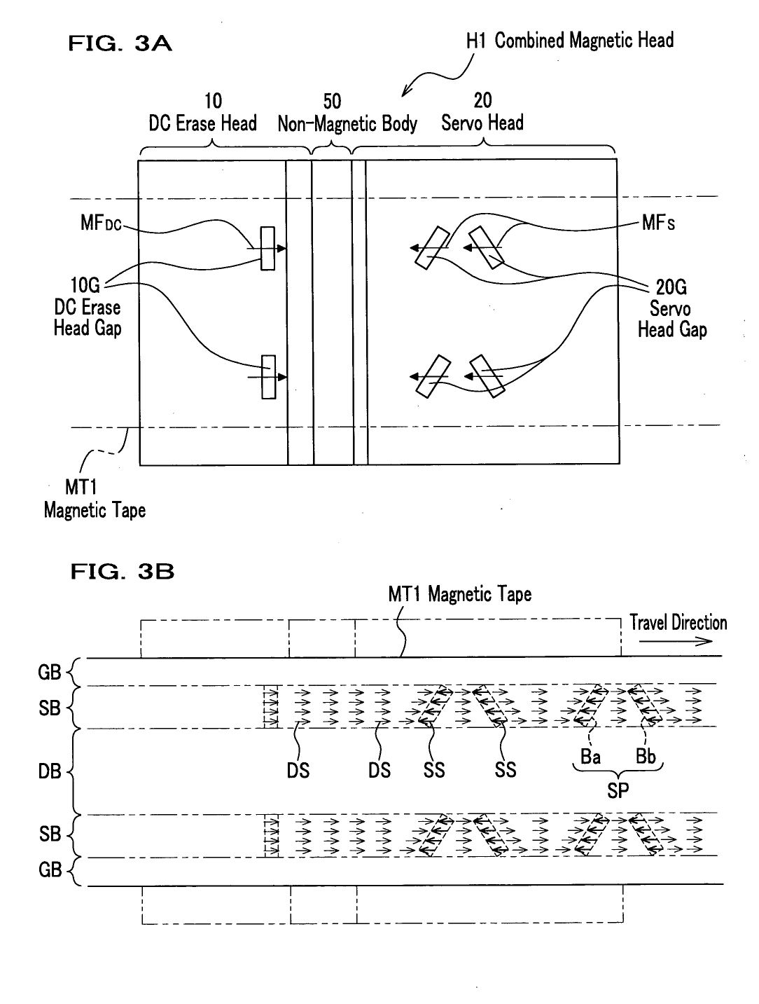

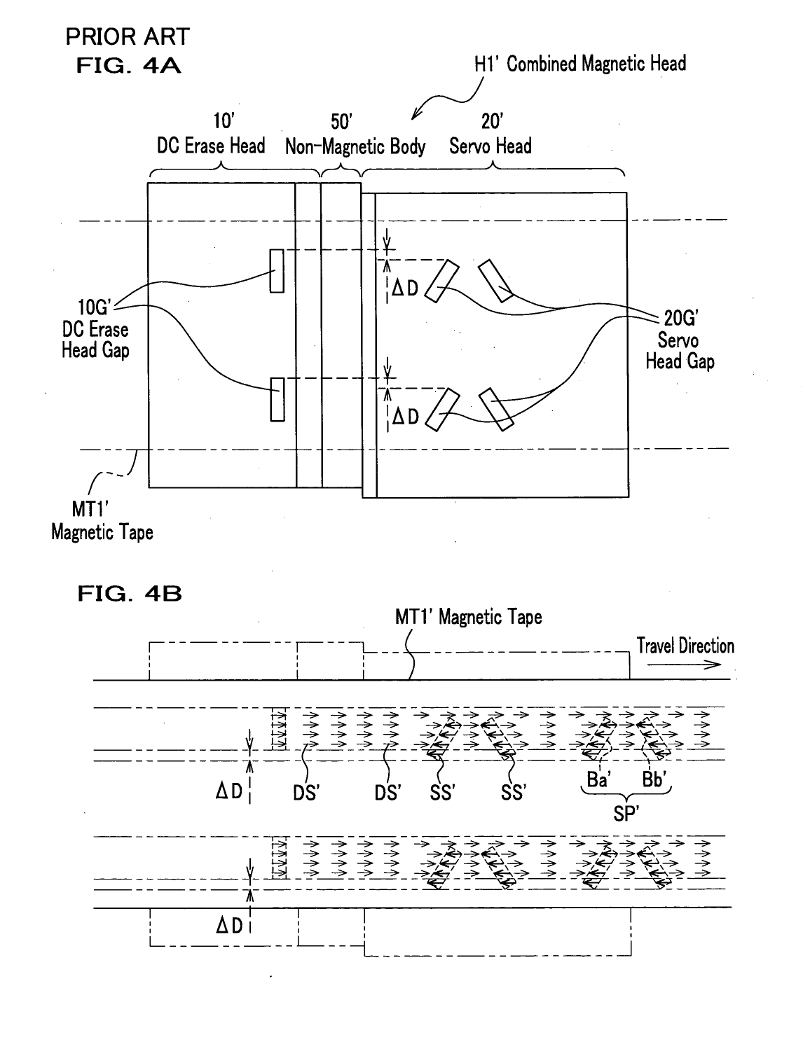

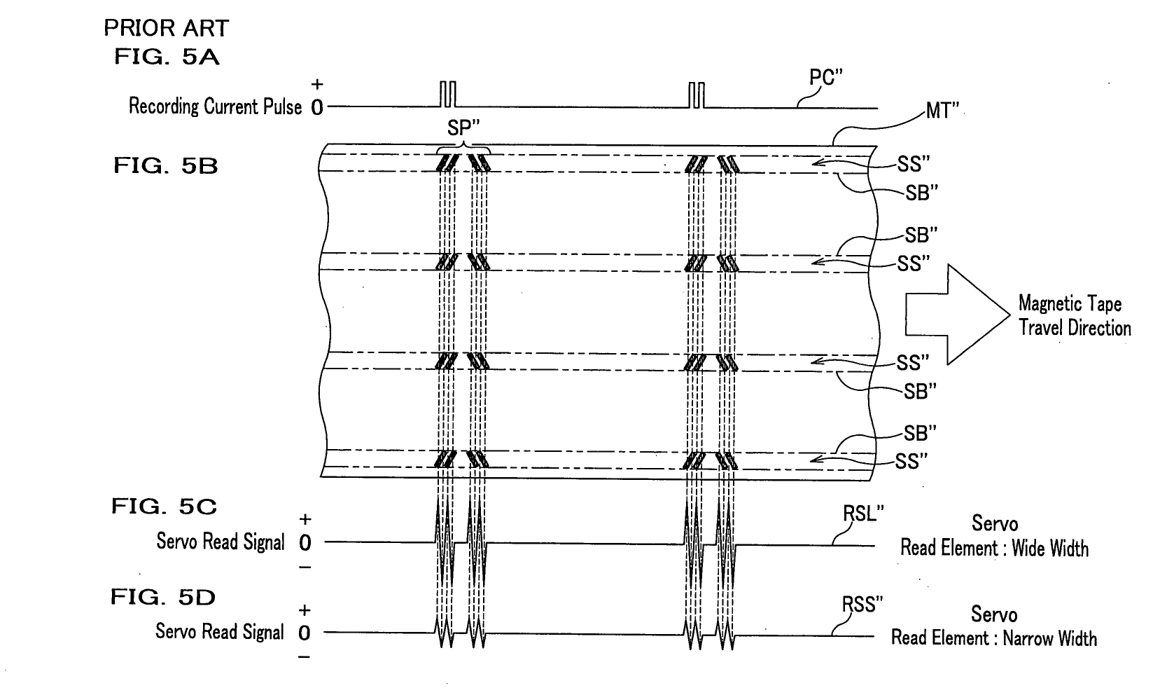

Next, a manufacturing method of the combined magnetic head H1 will be described, referring to FIGS. 2A to 2F.

First, as shown in FIG. 2A, join the first base member 11 and the non-magnetic body 50, which has the magnetic film 12 formed by a sputtering method and the like, with a glass G. Here, join with protruding the non-magnetic body 50 from a contact side of the magnetic tape MT1 of the first base member 11 so that the surface magnetic layers 13 and 23 described later can be magnetically insulated (see FIG. 2F) by the non-magnetic body 50.

In parallel with this as shown in FIG. 2B, join the second base member 21 and the third base member 22 with another glass G.

And as shown in FIG. 2C, further join these with still another glass G at a middle. Thus by the joinings described above, the DC erase head main body and the servo write head core main body result in being integrally configured through the non-magnetic body 50.

Then as shown in FIG. 2D, in an arrangement where DC erase head gap films 10GM forming at the DC erase head core main body and servo write head gap films 20GM forming at the servo write head core main body are aligned in the longitudinal directions of the magnetic tape MT1, simultaneously form the gap films 10GM and 20GM by the photolithography method of using one photomask.

Describing the second process in more detail, first form a silicon oxide film (hereinafter referred to as the SiO₂ film) so as to coat an upper face (side of the magnetic tape MT1) of the DC erase head main body and the servo write head core main body. And coat a photoresist (photosensitive resin) in a thin film on the SiO₂ film. Then using a light source such as a mercury lamp, simultaneously expose one photomask, where a predetermined photomask pattern is made, and the photoresist formed in the thin film on the upper face of the DC erase head main body and the servo write head core main body. Then develop the photoresist with development liquid, remove an unneeded photoresist, and then cleanse it with chemical liquid (rinse liquid). And removing (etching) a portion of the SiO₂ film, where the photoresist does not adhere, with HF (hydrofluoric acid) and the like, and then cleanse it with pure water. Last, by removing nothing but the photoresist by H₂SO₄(hydrosulfuric acid)/H₂O₂ (hydrogen peroxide) and the like, the DC erase head gap films 10GM and servo write head gap films 20GM consisting of silica (SiO₂) can be formed.

Here, make a photomask pattern so that the servo write head gap films 10GM and DC erase head gap films 20GM corresponding to the same servo bands SB of the magnetic tape MT1 are parallely formed in longitudinal directions of the photomask. In addition, also make the photomask pattern in lateral directions, corresponding to a distance of the servo bands SB of the magnetic tape MT1. Furthermore, reverse white/black of the photomask pattern, corresponding to a kind of used photoresist (photosensitive resin), that is, a positive type or a negative type.

And as shown in FIG. 2E, form a magnetic film 40 consisting of magnetic materials and the like by such a sputtering method so as to fill between the DC erase head gap films 10GM and the servo write head gap films 20GM and coat them.

And as shown in FIG. 2F, form the magnetic tape contact surface MS1 by polishing the magnetic film 40 with a polish tape and the like. Along with the polishing, the DC erase head gap films 10GM are shaped to the DC erase head gaps 10G; and the servo write head gap films 20GM are shaped to the servo write head gaps 20G. In addition, the magnetic film 40 is divided by the non-magnetic body 50 by being polished, is magnetically insulated, and becomes the surface magnetic layers 13 and 23.

Then the combined magnetic head H1 is manufactured by winding the coils 10B and 20B in the coil grooves 11a and 21a, respectively.

In accordance with such the manufacturing method of the combined magnetic head H1, after simultaneously forming the DC erase head gap films 10GM and the servo write head gap films 20GM with the same mask on the combined magnetic head main body by the photolithography method, the DC erase head gaps 10G and the servo write head gaps 20G are formed by nothing but the polishing and the like. That is, a displacement of lateral directions of the DC erase head gaps 10G and the servo write head gaps 20G that could be a manufacturing error, when conventionally assembling (combining) them, can be surely avoided.

Accordingly, in accordance with such the manufacturing method of the combined magnetic head H1, the DC erase head gaps 10G and the servo write head gaps 20G corresponding to the same servo bands SB can be parallely formed in a longitudinal direction.

[Operation of Combined Magnetic Head]

Subsequently, operation of the combined magnetic head H1 will be described, referring to FIGS. 3A and 3B.

As shown in FIG. 3A, arrange the combined magnetic head H1 so that the DC erase head 10 is at an upstream side and the servo head 20 is at a downstream side. And run the magnetic tape MT1 so as to contact the magnetic tape contact surface MS1 (see FIG. 1).

First, a process where the DC erase head 10 at the upstream side magnetizes the servo bands SB in the forward direction will be described.

Give a direct current to the coil 10B (see FIG. 1) from the current generation unit (not shown). The direct current being given, the coil 10B induces a magnetic flux flow transmitting to the DC erase head core 10A, in detail the magnetic film 11b, the magnetic film12, and the surface magnetic layer 13. The magnetic flux flow detours the DC erase head gaps 10G partially formed in the surface magnetic layer 13, and generates the leak magnetic fluxes MF_{DC} on the magnetic tape contact surface MS1. Although a direction of the leak magnetic fluxes MF_{DC} reverses depending on a polarity of the direct current flowing to the coil 10B, in the embodiment give the direct current so that the leak magnetic fluxes MF_{DC} become the forward direction.

And in accordance with the leak magnetic fluxes MF_{DC} the servo bands SB of the magnetic tape MT1 are magnetized by direct current, thereby direct current magnetization signals DS being written.

Next, a process where the servo head 20 at the downstream side writes the servo signals SS of a reverse direction will be described.

Give the current pulse to the coil 20B (see FIG. 1) from the current generation unit (not shown). If given, the coil 20B induces a magnetic flux flow transmitting to the servo head core 20A, in detail the second base member 21, the third base member 23, and the surface magnetic layer 23. The magnetic flux flow detours the servo gaps 20G partially formed in the surface magnetic layer 23, and generates the leak magnetic fluxes MF_{S} on the magnetic tape contact surface MS1. Although a direction of the leak magnetic fluxes MF_{S} reverse depending on the polarity of the current pulse flowing to the coil 20B, in the embodiment give the current pulse so that the leak magnetic fluxes MF_{S} become the reverse direction.

And in accordance with the leak magnetic fluxes MF_{S} the servo signals SS of the reverse direction are written on the servo bands SB of the magnetic tape MT1.

Here as described before, since the DC erase head gaps 10G and the servo head gaps 20G corresponding to the same servo bands SB are aligned in the longitudinal direction, the servo signals SS are written through the servo head gaps 20G without being displaced to a band portion where the direct current magnetization signals DS are written through the DC erase head gaps 10G. That is, it can be made to magnetize the portion of the servo bands SB of the magnetic tape MT1 in the forward direction without displacement by direct current, and to write the servo signals SS in the reverse direction.

The servo signals SS form the bursts Ba, which are magnetization portions for making the positive slanted angle for the travel direction of the magnetic tape MT1, and the bursts Bb, which are magnetization portions for making the negative slanted angle for the travel direction of the magnetic tape MT1 by the servo head gaps 20G, showing the approximately “bottom-open-reverse-V letter.“ And one burst Ba and one burst Bb configure one servo pattern SP. Furthermore, the servo pattern SP is repeated in the longitudinal directions of the magnetic tape MT1 by giving the current pulse at a predetermined interval.

Meanwhile, although in the embodiment one burst Ba and one burst Bb configure one servo pattern SP1, it is freely variable as needed: for example, each five of the bursts Ba and the bursts Bb configure each servo pattern SP, furthermore each of the bursts Ba and the bursts Bb is alternately arranged, and the like.

Accordingly, in accordance with the magnetic tape MT1 magnetized by the combined magnetic head H1, for example, when reading the servo signals SS with a servo read element appended to a recording magnetic head, a change rate and change amount of a magnetic field by the servo signals SS become large.

In other word, a magnetic direction largely varies from the forward direction to the reverse direction at a change portion from a base portion of the servo bands SB magnetized in the forward direction to the servo patterns SP magnetized in the reverse direction. In addition, the magnetic direction largely varies from the reverse direction to the forward direction also at a change portion from the portion of the servo patterns SP magnetized in the reverse direction to the base portion of the servo bands SB magnetized in the forward direction. Namely, at the change portions such large magnetic changes result in occurring, thereby the servo signals SS becoming able to be read with a large output by the servo read element.

Accordingly, the SN ratio of read signals of the servo signals SS by the servo read element is improved. And based on the read signals of the servo signals SS whose SN ratio is improved, a lateral directional position of the recording magnetic head becomes accurately controllable, thereby data signals being able to be written without being displaced to a data band DB.

In addition, the magnetic tape MT1 magnetized by such the combined magnetic head H1 can be used for a magnetic tape whose magnetic layer is thin; and since the tape MT1 is narrow in a width of data tracks, particularly it can be effectively used in a case that a width of the servo read element for reading the servo signals SS is narrower.

That is, conventionally care must be taken of the saturation phenomenon of the servo read element (MR (Magneto Resistive) element), so it is avoided to write servo signals on a portion magnetized by direct current with magnetizing them in a reverse direction. However, when making magnetic layers thinner and a width of data tracks narrower in order to increase a memory capacity per volume of a magnetic tape, an output of read signals of the servo signals can be enlarged by using the combined magnetic head H1.

In addition, in the magnetic tape MT1 magnetized by the combined magnetic head H1 the data band DB is demagnetized as it is. Accordingly, data signals recorded on the data band DB by the recording magnetic head (not shown) can be surely recorded without deterioration.

Thus, although one of preferred embodiments of the present invention is described, the invention is not limited to such the embodiment, and without departing from the spirit and scope of the invention, each component described in each of the embodiment may be combined as needed, and otherwise, for example, variations as below are available as needed.

Although in the embodiment the base portion of the servo bands SB is magnetized in the forward direction and the portion of the servo signals SS is magnetized in the reverse direction, on the contrary, the base portion of the servo bands SB is magnetized in the reverse direction and the portion of the servo signals SS is magnetized in the forward direction.

1. A combined magnetic head comprising:
a DC erase head for magnetizing a servo band of a magnetic tape in one of longitudinal directions of said magnetic tape with contacting the magnetic tape that is running; and
a servo write head for magnetizing a servo signal in a reverse direction for said one direction and writing the servo signal on said servo band, with contacting said magnetic tape,
wherein said DC erase head and said servo write head are integrally configured through a non-magnetic body, and
wherein a DC erase head gap of said DC erase head and a servo write head gap of said servo write head are aligned in said longitudinal directions, and are simultaneously formed with one mask by a photolithography method.

2. A manufacturing method of a combined magnetic head that magnetizes a servo band of a magnetic tape in one direction of longitudinal directions of said magnetic tape with contacting the magnetic tape, magnetizes a servo signal in a reverse direction for said one direction, and writes the servo signal on said servo band, the method comprising:
a first process where a DC erase head core main body and a servo write head core main body are integrally configured through a non-magnetic body, and
a second process for simultaneously forming a DC erase head gap film formed at said DC erase head core main body and a servo write head gap film formed at said servo write head core main body at an arrangement aligned in said longitudinal directions by a photolithography method of using one mask.

3. A combined magnetic head according to claim 1, wherein a first base member has a coil groove where a coil is wound, and on an inner circumference face thereof, a magnetic layer is formed by a sputtering method.

4. A combined magnetic head according to claim 1, wherein a first base member has a coil groove where a coil is wound, and on an inner circumference face thereof, a magnetic layer is formed by a plating method.

5. A combined magnetic head according to claim 1, wherein a DC erase head gap is formed of silica.

6. A combined magnetic head according to claim 3, wherein a DC erase head gap is formed of silica.

7. A combined magnetic head according to claim 4, wherein a DC erase head gap is formed of silica.

8. A combined magnetic head according to claim 1, wherein a servo write head gap is formed of silica.

9. A combined magnetic head according to claim 3, wherein a servo write head gap is formed of silica.

10. A combined magnetic head according to claim 4, wherein a servo write head gap is formed of silica.

11. A combined magnetic head according to claim 5, wherein a servo write head gap is formed of silica.

12. A combined magnetic head according to claim 6, wherein a servo write head gap is formed of silica.

13. A combined magnetic head according to claim 7, wherein a servo write head gap is formed of silica.

14. A combined magnetic head according to claim 1, wherein a magnetic layer, magnetic film, and surface magnetic layer of said DC erase head are formed of any of Permalloy, Sendust, Alperm, and amorphous.

15. A combined magnetic head according to claim 3, wherein a magnetic layer, magnetic film, and surface magnetic layer of said DC erase head are formed of any of Permalloy, Sendust, Alperm, and amorphous.

16. A combined magnetic head according to claim 4, wherein a magnetic layer, magnetic film, and surface magnetic layer of said DC erase head are formed of any of Permalloy, Sendust, Alperm, and amorphous.

17. A combined magnetic head according to claim 5, wherein a magnetic layer, magnetic film, and surface magnetic layer of said DC erase head are formed of any of Permalloy, Sendust, Alperm, and amorphous.

18. A combined magnetic head according to claim 1, wherein said non-magnetic body is formed of any of AlTiC, titan oxide calcium, and non-magnetic ferrite.

19. A combined magnetic head according to claim 3, wherein said non-magnetic body is formed of any of AlTiC, titan oxide calcium, and non-magnetic ferrite.

20. A combined magnetic head according to claim 4, wherein said non-magnetic body is formed of any of AlTiC, titan oxide calcium, and non-magnetic ferrite.
